(19) United States
(12) Patent Application Publication
(10) Pub. No.: US 2020/0272699 A1
(43) Pub. Date: Aug. 27, 2020

(54) AUGMENTED REALITY LANGUAGE TRANSLATION

(71) Applicant: QUALCOMM Incorporated, San Diego, CA (US)

(72) Inventor: Srivathsa Sridhara, Bhadravathi (IN)

(21) Appl. No.: 16/281,875

(22) Filed: Feb. 21, 2019

(51) Int. Cl. G06F 17/28; G10L 25/48; G10L 15/00; H04R 29/00

(52) U.S. Cl. CPC G06F 17/28; H04R 29/004; G10L 15/005; G10L 25/48

(57) ABSTRACT

Methods, systems, and devices for language translation are described. A device (e.g., a user equipment (UE), a pair of Bluetooth earbuds or a Bluetooth headset) may identify a sound signal originating in an augmented reality environment. The sound signal may include a representation in a language (e.g., a language translated from an original language). The device may, in response to reception of the sound signal, determine a set of characteristics of the sound signal based in part on a set of measurements of the sound signal (e.g., an intensity of the sound signal, an angle of arrival of the sound signal, a pitch of the sound signal, a loudness of the sound signal) and apply one or more characteristics from at least one of the set of characteristics to an output of the sound signal provide a natural rendering of the sound signal at the device.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems, as well as wireless local area networks (WLAN), such as Wi-Fi (i.e., Institute of Electrical and Electronics Engineers (IEEE) 802.11) and Bluetooth-related technology. Some examples of wireless communications systems, such as those outlined above, may be capable of supporting an augmented reality system with multiple characters (e.g., users, players).

### SUMMARY

An augmented reality system may support a fully immersive augmented reality experience, a non-immersive augmented reality experience, or a collaborative augmented reality experience. In some examples, an augmented reality environment may have multiple users from different areas of the world sharing in the augmented reality experience. Some examples of an augmented reality system may support language translation methods to further promote collaborative augmented reality experiences. These other methods, however, lack supporting a natural rendering of translated speech. The described techniques disclosed herein support translation techniques, such as speech translation, and more specifically augmented reality language translation to provide a natural rendering of translated speech to a target person in an augmented reality environment, by using one or more characteristics of a sound signal to deliver the natural rendering of the translated speech.

A method of language translation at a device is described. The method may include identifying a sound signal originating in an augmented reality environment, the sound signal including a representation in a language, determining a set of characteristics of the sound signal based on a set of measurements of the sound signal, applying, to the sound signal, one or more characteristics from at least one of the set of characteristics, and outputting the representation of the sound signal based on applying the one or more characteristics from the at least one of the set of characteristics.

An apparatus for language translation is described. The apparatus may include a processor, memory in electronic communication with the processor, and instructions stored in the memory. The instructions may be executable by the processor to cause the apparatus to identify a sound signal originating in an augmented reality environment, the sound signal including a representation in a language, determine a set of characteristics of the sound signal based on a set of measurements of the sound signal, apply, to the sound signal, one or more characteristics from at least one of the set of characteristics, and output the representation of the sound signal based on applying the one or more characteristics from the at least one of the set of characteristics.

Another apparatus for language translation is described. The apparatus may include means for identifying a sound signal originating in an augmented reality environment, the sound signal including a representation in a language, determining a set of characteristics of the sound signal based on a set of measurements of the sound signal, applying, to the sound signal, one or more characteristics from at least one of the set of characteristics, and outputting the representation of the sound signal based on applying the one or more characteristics from the at least one of the set of characteristics.

A non-transitory computer-readable medium storing code for language translation at a device is described. The code may include instructions executable by a processor to identify a sound signal originating in an augmented reality environment, the sound signal including a representation in a language, determine a set of characteristics of the sound signal based on a set of measurements of the sound signal, apply, to the sound signal, one or more characteristics from at least one of the set of characteristics, and output the representation of the sound signal based on applying the one or more characteristics from the at least one of the set of characteristics.

In some examples of the method, apparatuses, and non-transitory computer-readable medium described herein, the language includes a second language translated from an original language.

Some examples of the method, apparatuses, and non-transitory computer-readable medium described herein may further include operations, features, means, or instructions for receiving the sound signal from a source of the sound signal in the augmented reality environment, and measuring at least one of an intensity of the sound signal, an angle of arrival of the sound signal, a pitch of the sound signal, a loudness of the sound signal, a distance between the device and the source of the sound signal in the augmented reality environment, a time of arrival of the sound signal at the device, or a time of departure of the sound signal from the source of the sound signal in the augmented reality environment, or a combination thereof based on receiving the sound signal, and where the set of measurements of the sound signal includes the intensity of the sound signal, the angle of arrival of the sound signal, the pitch of the sound signal, the loudness of the sound signal, the distance between the device and the source of the sound signal in the augmented reality environment, the time of arrival of the sound signal at the device, or the time of departure of the sound signal from the source of the sound signal in the augmented reality environment, or a combination thereof

Some examples of the method, apparatuses, and non-transitory computer-readable medium described herein may further include operations, features, means, or instructions for identifying a time of departure of the sound signal from a source of the sound signal in the augmented reality environment based on the set of measurements of the sound signal, and determining a delay including a difference in time of arrival of the sound signal at a first microphone of the device and time of arrival of the sound signal at a second microphone of the device based on the set of measurements of the sound signal, and where the set of characteristics includes the time of departure of the sound signal and the delay associated with the difference in the times of the arrivals.

Some examples of the method, apparatuses, and non-transitory computer-readable medium described herein may further include operations, features, means, or instructions for determining a difference in intensity associated with the sound signal based on the set of measurements of the sound signal, where the difference in intensity includes a difference between an intensity of the sound signal at a first microphone of the device and an intensity of the sound signal at a second microphone of the device, and where the set of characteristics includes the difference in intensity.

Some examples of the method, apparatuses, and non-transitory computer-readable medium described herein may further include operations, features, means, or instructions for determining an angular offset between the device and a source of the sound signal in the augmented reality environment using a sensor of the device, determining a second set of characteristics that may be based on the angular offset, where the second set of characteristics includes at least one of an intensity of the sound signal, a pitch of the sound signal, a loudness of the sound signal, or a combination thereof, and applying, to the sound signal, one or more characteristics from at least one of the second set of characteristics that may be based on the angular offset, where outputting the representation of the sound signal may be based on applying the one or more characteristics from at least one of the second set of characteristics.

Some examples of the method, apparatuses, and non-transitory computer-readable medium described herein may further include operations, features, means, or instructions for translating a representation of the sound signal from the language into a second language, where outputting the representation of the sound signal includes, and outputting the translated representation of the sound signal in the second language based on applying the one or more characteristics from the at least one of the set of characteristics.

Some examples of the method, apparatuses, and non-transitory computer-readable medium described herein may further include operations, features, means, or instructions for establishing a connection with a second device based on a connection procedure, and receiving the sound signal from the second device in communication with the device, where identifying the sound signal may be based on receiving the sound signal from the second device in communication with the device.

Some examples of the method, apparatuses, and non-transitory computer-readable medium described herein may further include operations, features, means, or instructions for receiving the set of measurements of the sound signal from the second device in communication with the device based on the connection, where determining the set of characteristics of the sound signal may be based on receiving the set of measurements of the sound signal.

In some examples of the method, apparatuses, and non-transitory computer-readable medium described herein, the device includes a pair of Bluetooth earbuds or a Bluetooth headset.

In some examples of the method, apparatuses, and non-transitory computer-readable medium described herein, the device includes a UE.

In some examples of the method, apparatuses, and non-transitory computer-readable medium described herein, the representation includes speech in a verbal form or a written form.

### BRIEF DESCRIPTION OF THE DRAWINGS

FIGS. 1 and 2 illustrates example of a wireless communications system for language translation that supports augmented reality language translation in accordance with aspects of the present disclosure.

FIGS. 3 and 4 illustrate example of a process flow that supports augmented reality language translation in accordance with aspects of the present disclosure.

FIGS. 5 and 6 show block diagrams of devices that support augmented reality language translation in accordance with aspects of the present disclosure.

FIG. 7 shows a block diagram of a language translation manager that supports augmented reality language translation in accordance with aspects of the present disclosure.

FIG. 8 shows a diagram of a system including a device that supports augmented reality language translation in accordance with aspects of the present disclosure.

FIGS. 9 through 11 show flowcharts illustrating methods that support augmented reality language translation in accordance with aspects of the present disclosure.

### DETAILED DESCRIPTION

An augmented reality system may support a fully immersive augmented reality experience, a non-immersive augmented reality experience, or a collaborative augmented reality experience. For example, an augmented reality system may support perception of real and virtual sounds originating in an augmented reality environment, motion tracking to enable interactivity and location-awareness in the augmented reality environment, audio rendering to deliver audio augmented reality content in the augmented reality environment, and spatial rendering to display spatialized augmented reality content in the augmented reality environment. In some examples, an augmented reality environment may have multiple users sharing in the augmented reality experience. Some examples of an augmented reality system may support language translation methods to further promote collaborative augmented reality experiences (e.g., a conversation in a particular language can be translated live (e.g., in real time) to another language).These other methods, however, lack supporting a natural rendering of the translated speech. The described techniques disclosed herein support speech translation techniques, and more specifically augmented reality language translation to provide a natural rendering of translated speech to a target person in an augmented reality environment. In some cases, the translation may include using characteristics (e.g., an intensity, a distance, an angle of arrival, and the like) of a sound signal to deliver the natural rendering of the translated speech.

To attain the benefits of augmented reality language translation, and more specifically a natural rendering of translated speech, one or more characteristics of a sound signal may be determined, measured, and/or collected (e.g., via sensors). The one or more characteristics of a sound signal may relate to spatial hearing and support augmented reality language translation to provide a natural rendering of translated speech based in part on perception of the sound signal at or related to a target person. For example, by measuring at least one of an intensity of a sound signal, an angle of arrival of the sound signal, a pitch of the sound signal, a loudness of the sound signal, a distance between a person and a source of the sound signal in an augmented reality environment, a time of arrival of the sound signal at the person, or a time of departure of the sound signal from the source of the sound signal in the augmented reality environment, or a combination thereof (among other potential parameters or conditions), may support natural rendering of translated speech.

In some examples, a head-related transfer function also referred to as an anatomical transfer function may be a response relating to arrival characteristics of a sound signal and may be used to support a natural rendering of translated speech. A person may observe a sound spatial position based on differences between arrival characteristics of the sound signal. For example, a head-related transfer function may be a response that characterizes how an ear receives a sound signal from a point in space (e.g., in an augmented reality environment). The relationship between the spatial position of a sound source of the sound signal and the arrival characteristics of the sound signal at a target person may be represented by a pair of head-related transfer functions. A pair of head-related transfer functions for a person can be used to control outputting a sound signal to come from a particular point in space. Thus, in addition to applying one or more characteristics to a sound signal, the sound signal with the applied one or more characteristics may be filtered by a head-related transfer function, as merely one non-limiting example, to output (e.g. render) a representation (e.g., translated speech) of the sound signal at or to a target person, which may result in a natural rendering of the translated speech.

Aspects of the disclosure are initially described in the context of a wireless communications system. Aspects of the disclosure are then illustrated by and described with reference to process flows that relate to augmented reality language translation. Aspects of the disclosure are further illustrated by and described with reference to apparatus diagrams, system diagrams, and flowcharts that relate to augmented reality language translation.

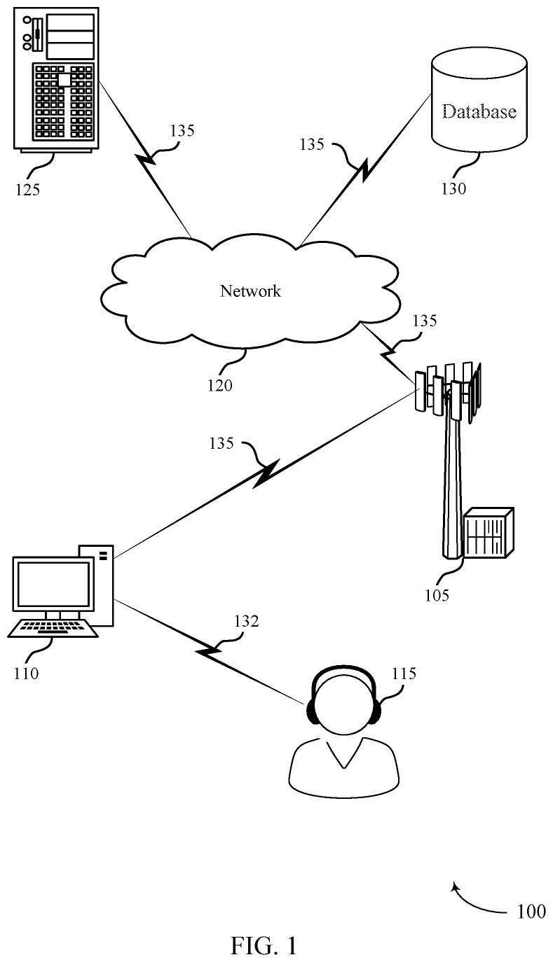

FIG. 1 illustrates a wireless communications system 100 that supports augmented reality language translation in accordance with aspects of the present disclosure. In some examples, the wireless communications system 100 may be a multiple-access wireless communications system, for example, such as a fourth generation (4G) systems such as Long Term Evolution (LTE) systems, LTE-Advanced (LTE-A) systems, or LTE-A Pro systems, and fifth generation (5G) systems which may be referred to as New Radio (NR) systems, as well as wireless local area networks (WLAN), such as Wi-Fi (i.e., Institute of Electrical and Electronics Engineers (IEEE) 802.11) and Bluetooth-related technology. The wireless communications system 100 may include a base station 105, a device 110, a device 115 (which may in some cases be a paired device), a server 125, and a database 130. In some examples, the device 110 may be referred to herein as a listening device, while the device 115 may be referred to herein as a playback device. In some examples, either or both the device 110 and the device 115 may additionally or alternatively perform similar or same operations that support augmented reality language translation.

The device 110 and the device 115 may be stationary and/or mobile. In some examples, the device 110 may be a personal computing device, a desktop, a laptop, mobile computing device, or a head mounted display (HMD), etc. The device 110 may additionally, or alternatively, include or be referred to by those skilled in the art as a user equipment (UE), a user device, a smartphone, a BLUETOOTH device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology.

The device 110 may be configured to allocate graphics resources, handle audio and/or video streams, and/or render multimedia content (e.g., render audio and/or video streams (e.g., augmented reality language translation)) for a augmented reality experience as described herein. For example, the device 110 may communicate one or more frames with the device 115 to provide an augmented reality experience. A frame may be a stereoscopic three dimensional (3D) visualization that is transmitted to the device 115 for presentation.

In some examples, the device 115 may be an HMD. As an HMD, the device 115 may be worn by a user. In some examples, the device 115 may be configured with one or more sensors to sense a position of the user and/or an environment surrounding the HMD to generate information when the user is wearing the HMD. The information may include movement information, orientation information, angle information, etc. regarding the device 115. In some examples, the device 115 may be configured with a microphone (e.g., a single microphone or an array of microphones) for capturing audio and one or more speakers for broadcasting the audio. The device 115 may also be configured with a set of lenses and a display screen for the user to view and be part of an augmented reality experience in an augmented reality system.

In some examples, an augmented reality environment may have multiple users from different areas of the world sharing in the augmented reality experience. Some examples of an augmented reality system may support language translation methods to further promote collaborative augmented reality experiences (e.g., a discussion in a particular language can be translated live (e.g., in real time) to another language). These other methods, however, may not support a natural rendering of the translated speech. That is, these methods may provide a mechanical translated speech output, rather than a natural rendering of translated speech, which leads to degraded user experience among other problems. In addition, these methods further pose challenges when there is more than one user speaking in a scene (e.g., frame, plane) in an augmented reality. As a result, these methods are lacking in capability to relate the translated speech to the appropriate person. The described techniques disclosed herein support speech translation, and more specifically augmented reality language translation to provide a natural rendering of translated speech to a target person in the augmented reality environment by using one or more characteristics of a sound signal to deliver the natural rendering of the translated speech.

To achieve the advantages of natural rendering of augmented reality language translation, the device 110 and/or the device 115 may measure and/or determine one or more characteristics of a sound signal as well as one or more aspects associated with the sound signal at or related to a target person. The one or more characteristics of a sound signal may, in some examples, relate to spatial hearing and support augmented reality language translation to provide a natural rendering of translated speech to a target person in the augmented reality environment. For example, the device 110 and/or the device 115 may measure at least one of an intensity of a sound signal, an angle of arrival of the sound signal, a pitch of the sound signal, a loudness of the sound signal, a distance between the device 110 and/or the device 115 and a source of the sound signal in an augmented reality environment, a time of arrival of the sound signal at the device 110 and/or the device 115, a time of departure of the sound signal from the source of the sound signal in the augmented reality environment, or one or more other characteristics, or a combination thereof.

In some examples, the device 110 and the device 115 may use function, such as a head-related transfer function which may also be referred to as an anatomical transfer function, that may be a response relating to arrival characteristics of a sound signal. A person may observe a sound spatial position based on differences between arrival characteristics of the sound signal. For example, a function, including but not limited to a head-related transfer function, may be a response that characterizes how an ear receives a sound signal from a source, such as a point in space (e.g., in an augmented reality environment). The relationship between the spatial position of a sound source of the sound signal and the arrival characteristics of the sound signal at or related to a target person (e.g., of the device 110 and/or the device 115) may be represented by a one or more functions, such as pair of head-related transfer functions. A pair of head-related transfer functions for a target person may, in some cases, be used to synthesize a binaural sound output that seems to come from a particular point in space. Thus, a head-related transfer function may define how a sound signal from a specific point in space will arrive at the target person. In some examples, the device 110 and/or the device 115 may detect the sound signal and determine one or more characteristics of the sound signal at a second location that is different from the location of the target person. For example, the device 110 (e.g., a UE or a first headphone of a pair of headphones) may be at a first location and detect the sound signal and determine one or more characteristics of the sound signal, while the device 115 (e.g., a second headphone of the pair of headphones) may be at a second location different from the first location. Here, the device 110 may perform the processes described herein, while the device 115 may broadcast the processed sound signal, as described herein.

In some examples, the device 110 and the device 115 may control (e.g., the rendering) of the sound signal reaching a listener's ears. Controlling the ear input signals of the left and the right ear independently may allow the device 110 and the device 115 to encode the one or more characteristics (e.g., intensity, direction, angle) of a sound signal that may evoke the perception and localization of the sound signal in the augmented reality environment. Thus, the device 110 and the device 115 may for spatial sound signal rendering support channel separation at the ears of the listener, to enable the output of these one or more characteristics. By applying one or more characteristics to a sound signal, and outputting a representation (e.g., translated speech) of the sound signal based in part on applying the one or more characteristics, the device 110 and the device 115 may provide a natural rendering of translated speech to a target person in the augmented reality environment.

The device 115 may include Bluetooth-enabled devices capable of pairing with other Bluetooth-enabled devices (e.g., such as the device 110), which may include wireless headsets, earbuds, speakers, ear pieces, headphones, display devices (e.g., TVs, computer monitors), microphones, etc. The device 110 and the device 115 may be able to communicate directly with each other (e.g., using a peer-to-peer (P2P) or device-to-device (D2D) protocol, or Bluetooth protocol). By way of example, the device 115 (e.g., headset) may be connected to the device 110 (e.g., mobile phone) over a Bluetooth connection, or the like.

Bluetooth communications may refer to a short-range communication protocol and may be used to connect and exchange information between the device 110 and the device 115 (e.g., between mobile phones, computers, digital cameras, wireless headsets, speakers, keyboards, mice or other input peripherals, and similar devices). Bluetooth systems (e.g., aspects of the wireless communications system 100) may be organized using a master-slave relationship employing a time-division duplex protocol having, for example, defined time slots of 625 mu seconds, in which transmission alternates between the master device (e.g., the device 110) and one or more slave devices (e.g., the device 115). In some examples, the device 110 may generally refer to a master device, and the device 115 may refer to a slave device in the wireless communications system 100. As such, in some examples, a device may be referred to as either the device 110 or a device 115 based on the Bluetooth role configuration of the device. That is, designation of a device as either a device 110 or a device 115 may not necessarily indicate a distinction in device capability, but rather may refer to or indicate roles held by the device in the wireless communications system 100. Generally, device 110 may refer to a wireless communication device capable of wirelessly exchanging data signals with another device, and device 115 may refer to a device operating in a slave role, or to a short-range wireless device capable of exchanging data signals with the mobile device (e.g., using Bluetooth communication protocols).

A Bluetooth-enabled device may be compatible with certain Bluetooth profiles to use desired services. A Bluetooth profile may refer to a specification regarding an aspect of Bluetooth-based wireless communications between devices. That is, a profile specification may refer to a set of instructions for using the Bluetooth protocol stack in a certain way, and may include information such as suggested user interface formats, particular options and parameters at each layer of the Bluetooth protocol stack, etc. For example, a Bluetooth specification may include various profiles that define the behavior associated with each communication endpoint to implement a specific use case. Profiles may thus generally be defined according to a protocol stack that promotes and allows interoperability between endpoint devices from different manufacturers through enabling applications to discover and use services that other nearby Bluetooth-enabled devices may be offering. The Bluetooth specification defines device role pairs that together form a single use case called a profile. One example profile defined in the Bluetooth specification is the Handsfree Profile (HFP) for voice telephony, in which one device implements an Audio Gateway (AG) role and the other device implements a Handsfree (HF) device role. Another example is the Advanced Audio Distribution Profile (A2DP) for high-quality audio streaming, in which one device (e.g., device 110-a) implements an audio source device (SRC) role and another device (e.g., device 115-a) implements an audio sink device (SNK) role.

For a commercial Bluetooth-enabled device that implements one role, another device that implements the also corresponding role may be present within the radio range of the Bluetooth-enabled device. For example, in order for an HF device such as a Bluetooth headset to function according to the Handsfree Profile, a device implementing the AG role (e.g., a cell phone) may have to be present within radio range. Likewise, in order to stream high-quality mono or stereo audio according to the A2DP, a device implementing the SNK role (e.g., Bluetooth headphones or Bluetooth speakers) may have to be within radio range of a device implementing the SRC role (e.g., a stereo music player). A link 132 established between two Bluetooth-enabled devices (e.g., between the device 110 and the device 115) may provide for communications or services (e.g., according to some Bluetooth profile). Other Bluetooth profiles supported by Bluetooth-enabled devices may include Bluetooth Low Energy (BLE) (e.g., providing considerably reduced power consumption and cost while maintaining a similar communication range), human interface device profile (HID) (e.g., providing low latency links with low power requirements), etc.

The server 125 may be a computing system or an application that may be an intermediary node in the wireless communications system 100 between the device 110, or the device 115, or the database 130. The server 125 may include any combination of a data server, a cloud server, a server associated with an augmented reality service provider, proxy server, mail server, web server, application server (e.g., gaming application server), database server, communications server, home server, mobile server, or any combination thereof. The server 125 may also transmit to the device 110 or the device 115 a variety of augmented reality information, such as rendering instructions, configuration information, control instructions, and other information, instructions, or commands relevant to performing augmented reality language translation.

The database 130 may store data that may include graphics resources, audio and/or video streams, and/or rendered multimedia content (e.g., rendered audio and/or video streams (e.g., frames)) for an augmented reality environment, or commands relevant to augmented reality language translation for the device 110 and/or the device 115. The device 110 and the device 115 may retrieve the stored data from the database via the network 120 using communication links 135. In some examples, the database 130 may be a relational database (e.g., a relational database management system (RDBMS) or a Structured Query Language (SQL) database), a non-relational database, a network database, an object-oriented database, among others that stores the variety of information, such as instructions or commands relevant to augmented reality language translation.

The network 120 that may provide encryption, access authorization, tracking, Internet Protocol (IP) connectivity, and other access, computation, modification, and/or functions. Examples of network 120 may include any combination of cloud networks, local area networks (LAN), wide area networks (WAN), virtual private networks (VPN), wireless networks (using 802.11, for example), cellular networks (using 3G, 4G, LTE, or NR systems (e.g., 5G for example), etc. Network 120 may include the Internet.

The base station 105 may wirelessly communicate with the device 110 and the device 115 via one or more base station antennas. Base station 105 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. The device 115 and the device 115 described herein may be able to communicate with various types of base stations and network equipment including macro eNBs, small cell eNBs, gNBs, relay base stations, and the like.

The communication links 135 shown in the wireless communications system 100 may include uplink transmissions from the device 115 and/or the device 115 to the base station 105, or the server 125, and/or downlink transmissions, from the base station 105 or the server 125 to the device 115 and the device 115. The downlink transmissions may also be called forward link transmissions while the uplink transmissions may also be called reverse link transmissions. The communication links 135 may transmit bidirectional communications and/or unidirectional communications. The communication links 135 may include one or more connections, including but not limited to, 345 MHz, Wi-Fi, BLUETOOTH, BLUETOOTH Low-Energy, cellular, Z-WAVE, 802.11, peer-to-peer, LAN, wireless local area network (WLAN), Ethernet, FireWire, fiber optic, and/or other connection types related to wireless communications systems.

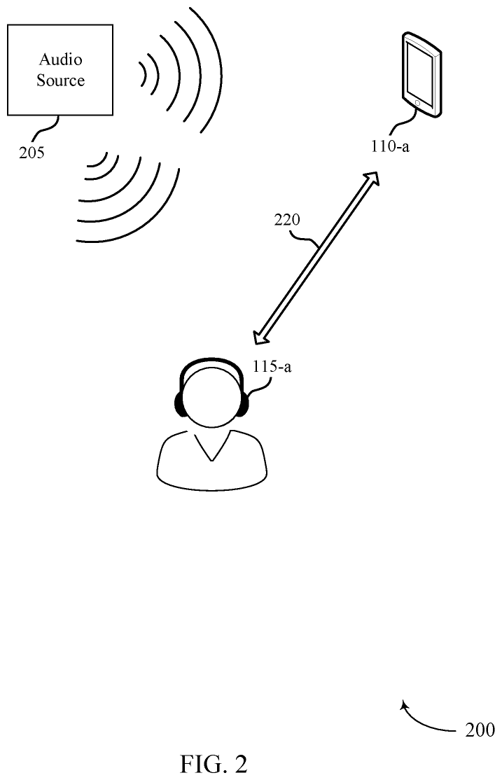

FIG. 2 illustrates an example of a wireless communications system 200 that supports augmented reality language translation in accordance with aspects of the present disclosure. In some examples, the wireless communications system 200 may implement aspects of wireless communications system 100. For example, the wireless communications system 200 may include a device 110-a, a device 115-a, which may be examples of the corresponding devices described with reference to FIG. 1. The wireless communications system 200 may illustrate an augmented reality system, and more specifically FIG. 2 may illustrate the device 110-a and the device 115-a capability to localize a sound signal within an augmented reality environment, as well as provide a natural rendering of augmented reality language translation to the sound signal.

In an augmented reality environment, an audio source 205 may output (e.g., transmit, broadcast) a sound signal. In some examples, the audio source 205 may directly or indirectly output a sound signal towards the device 110-a or the device 115-a. For example, an audio source 205 may be another user in the augmented reality environment speaking to a user of the device 110-a and the device 115-a. In some examples, the sound signal emitted by the audio source 205 may be in a language not understood by the user of the device 110-a and the device 115-a. As such, it may be necessary to translate the language into a second language understood by the user, as described further in detail below.

Alternatively, the audio source 205 may be audible gestures, audio signaling devices, audio playback devices, mechanical systems, and so forth. In the example of FIG. 2, either or both the device 110-a and the device 115-a may receive the sound signal from the audio source 205 and process the sound signal appropriately (e.g., sound localization, augmented reality language translation). A portion or all of the processing of the sound signal may be performed by the device 110-a and/or the device 115-a.

By way of example, the device 110-a may be a listening device, which may receive the sound signal from the audio source 205. After receiving, or as part of receiving the sound signal, the device 110-a may localize the sound signal within the augmented reality environment. By localizing the sound signal, the device 110-a may be capable of determining one or more aspects related to, such as a spatial origin of, the sound signal within the augmented reality environment. To localize the sound signal, the device 110-a may measure one or more characteristics of the sounds signal, such as, at least one of an intensity of the sound signal, an angle of arrival of the sound signal, a pitch of the sound signal, a loudness of the sound signal, a distance between the device 110-a and the audio source 205 of the sound signal in the augmented reality environment, a time of arrival of the sound signal at the device 110-a, or a time of departure of the sound signal from the audio source 205 of the sound signal in the augmented reality environment, or a combination thereof. In further examples, the one or more characteristics may sampled for desired frequencies (e.g., a range of audible frequencies for humans, such as 20 Hz to 20 kHz).

In an example, the device 110-a may identify a time of departure of the sound signal from the audio source 205 based in part on a set of measurements (e.g., a time of arrival) of the sound signal at different devices (e.g., microphones of an array of microphones) associated with the device 110-a, and determine a delay including a difference in time of arrival of the sound signal at the different devices. In this example, at least a subset of the set of characteristics of the sound signal may include the delay (e.g., difference in time of arrival of the sound signal). In other examples, the device 110-a may determine a difference in intensity associated with the sound signal based in part on the set of measurements of the sound signal at different devices (e.g., microphones of an array of microphones) associated with the device 110-a. Here, at least a subset of the set of characteristics of the sound signal may include the difference in intensities of the sound signal at different devices (e.g., microphones of an array of microphones) associated with the device 110-a.

The device 110-a may use a subset or the set of characteristics determined of the sound signal to localize the sound signal in the augmented reality environment. Although the above localization of the sound signal is performed by the device 110-a, the device 115-a may be additionally, or alternatively, be capable of performing the localization of the sound signal. Alternatively, the device 110-a may transmit the set of measurements of the sound signal to the device 115-a via communication link 220 (e.g., wired or wireless connection).

Where the sound signal emitted by the audio source 205 may be in a language not understood by the user of the device 110-a and the device 115-a, it may be necessary to translate the language into a language understood by the user, as described further in detail below. The sound signal may include a representation in a language that may be speech in a verbal form or a written form. Thus, the device 110-a may convert the sound signal (e.g., speech) from verbal form to written form (e.g., text). After converting the sound signal from verbal form to written form, the device 110-a may translate the original language of the sound signal to a second language. In some examples, the device 110-a may identify the second language based in part on a preference (e.g., a default language) of the user associated with the device 110-a and the device 115-a. The device 110-a may then convert the translated speech from written form back into verbal form based in part on the preference.

In some examples, when the device 110-a is the listening device and the device 115-a is a playback device, the device 110-a may forward the translated representation (e.g., translated speech) of the sound signal to the device 115-a for playback. To provide a natural rendering of the translated speech of the sound signal by the device 115-a, the device 110-a may also transmit additional information (e.g., the set of characteristics of the sound signal) to the device 115-a. For example, the additional information may include the intensity of the sound signal, the angle of arrival of the sound signal, the pitch of the sound signal, the loudness of the sound signal, the distance between the device and the source of the sound signal in the augmented reality environment, or a combination thereof.

The device 115-a may receive the translated representation (e.g., translated speech) of the sound signal, as well as the additional information. Using the additional information provided by the device 110-a, the device 115-a may determine a comparative delay (e.g., a difference in time of arrival of the sound signal in left and right ears), or a difference in intensity associated with the sound signal (e.g., a difference in intensity of the sound signal in left and right ears), or both. In some examples, the device 115-a may consider base times along with differences in time observed at both channels (e.g., earbuds (e.g., ears of a user) of the device 115-a). For example, a first sentence associated with the sound signal may have been spoken at x time, and it had perceived delay of Δx between left and right ear. While a second sentence associated with the sound signal may have been spoken at y time, and it had perceived delay of Δy between left and right. The paired device may use, during the playback, one or more of x, y, Δx, and Δy.

The device 115-a may determine a second set of characteristics of the sound signal that may include subset or the set of characteristics determined by the device 110-a, as well as the comparative delay and/or the difference in intensity determined by the device 115-a. The device 115-a may then apply, a subset of the second set or the entire second set of characteristics to the sound signal. The device 115-a may then output (e.g., playback) the translated representation (e.g., translated speech) of the sound signal to the user of the device 115-a. Thus, the device 115-a may be capable of outputting a sound signal (e.g., a translated sound signal) and controlling its perception perceived by a listener by using one or more characteristics of the sound signal giving the sound signal a natural rendering in the augmented reality environment.

In some examples, perceived localization of the audio source 205 may be stale (e.g., no longer correct, outdated) when playing back the translated representation (e.g., translated speech) of the sound signal to the user of the device 115-a, due to slight delay between original speech and playback after translation. For example, a user wearing the device 115-a (e.g., HMD) may move around in the augmented reality environment. To account for the movement, the device 115-a may use one or more sensors (e.g., a motion sensor, a magneto sensor) to offset an angular placement away or towards the audio source 205. As such, perceived sound localization may be accurate while playback.

By way of example, a human speaker, the device 110-a and the device 115-a may in two-dimensional augmented reality environment, the device 110-a may use an array of microphone to determine an angular position that is an angular placement of the human speaker relative to the device 110-a. The device 110-a may, in some examples, then determine an absolute angular placement of the human speaker with respect to magnetic north direction. This absolute angular placement may be communicated to the device 115-a by the device 110-a. As such, the device 115-a may be aware of the actual position of the human speaker by using a sensor (e.g., magneto meter) and the absolute angular placement.

The device 115-a may use one or more sensors (e.g., a motion sensor, a magneto sensor) to offset an angular placement away or towards the audio source 205. As such, perceived sound localization may be accurate while playback, For example, the device 110-a (and/or the device 115-a) may determine an angular offset between the device 110-a (and/or the device 115-a) and the audio source 205 using a sensor of the device 110-a (and/or the device 115-a). The device 110-a (and/or the device 115-a) may adjust, modify, or determine another set of characteristics that are based in part on the angular offset. The set of characteristics may include at least one of an intensity of the sound signal, a pitch of the sound signal, a loudness of the sound signal, or a combination thereof associated with the angular offset of the audio source 205. The device 110-a (and/or the device 115-a) may apply, to the sound signal, one or more characteristics from the set of characteristics that are based in part on the angular offset. In other examples, the audio source 205 may move (e.g., change locations) within the augmented reality environment. In this examples, the device 110-a and/or the device 115-a may use latest placement samples or original samples to determine an angular placement of the audio source 205. If the audio source 205 continuous to broadcast sound signals (e.g. a user continue to speak) the device 110-a and/or the device 115-a may use latest placement samples (e.g., location information) for sound localization. Thus, the device 115-a may be capable of outputting a sound signal (e.g., a translated sound signal) and controlling its perception perceived by a listener, even when movement in the augmented reality environment exists, by using one or more characteristics of the sound signal giving the sound signal a natural rendering in the augmented reality environment.

The techniques described herein may provide improvements in augmented reality language translation. Furthermore, the techniques described herein may provide benefits and enhancements to the operation of the device 110-a and the device 115-a. For example, by supporting an effective technique for natural rendering of augmented reality language translation, the operational characteristics, such as power consumption, processor utilization (e.g., CPU processing utilization), and memory usage of the device 110-a and the device 115-a may be reduced. The techniques described herein may also provide efficiency to the device 110-a and the device 115-a by reducing latency associated with processes related to natural rendering of augmented reality language translation.

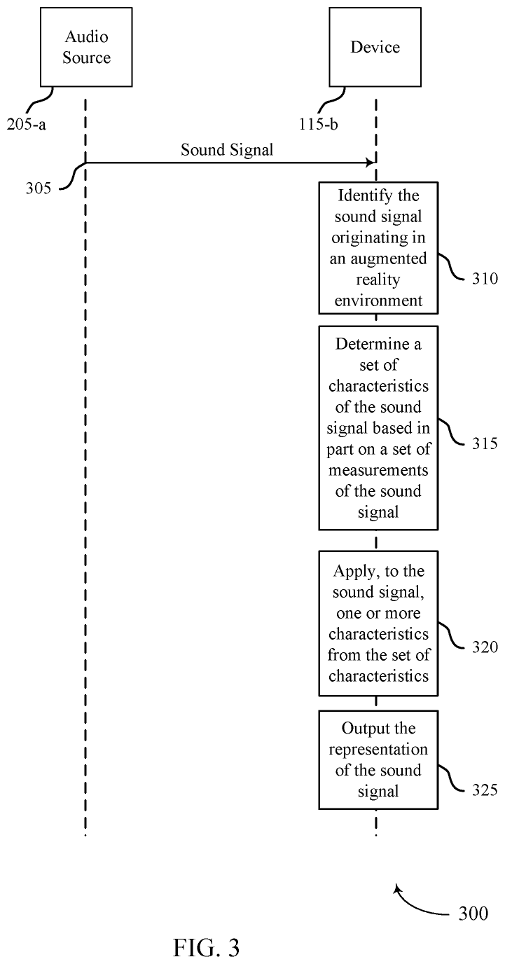

FIG. 3 illustrates an example of a process flow 300 that supports augmented reality language translation in accordance with aspects of the present disclosure. In some examples, process flow 300 may implement aspects of wireless communications system 100. The process flow 300 may include an audio source 205-b, a device 110-b, and a device 115-b, which may be examples of the corresponding devices described with reference to FIGS. 1 and 2. In the following description of the process flow 300, the operations between the audio source 205-a and the device 115-b may be transmitted in a different order than the exemplary order shown, or the operations performed by the audio source 205-a and the device 115-b may be performed in different orders or at different times. Certain operations may also be omitted from the process flow 300, and/or other operations may be added to the process flow 300.

At 305, the audio source 205-a may broadcast a sound signal to the device 115-b. In some examples, the device 110-c may be an HMD capable to operate as both a listening device and a playback device. The audio source 205-a may be another device in an augmented reality, or another user speaking in the augmented reality, or an object emitting sound in the augmented reality, or the like. The audio source 205-a may additionally, or alternatively be user speech, audible gestures, audio signaling devices, audio playback devices, mechanical systems, and so forth.

At 310, the device 115-b may identify the sound signal originating in an augmented reality environment. For example, the device 115-b may identify the sound signal originating in the augmented reality environment based in part on receiving the sound signal directly from the audio source 205-a, which may be another individual, or a non-player character (NPC) in the augmented reality environment, or any other element (e.g., object) capable of broadcasting a sound signal in the augmented reality environment.

By way of example, in a scene of an augmented reality environment, there may be three users (e.g., user-A, user-B, and user-C). User-A may be associated with the device 115-b, while user-B and user-C may be other individuals participating in the collaborative augmented reality experience. In some examples, user-B may be speaking in the augmented reality environment, for example directly to user-A or to both user-A and user-C. As such, the sound signal originating in the augmented reality environment may be related to the user-B speaking. To relate the sound signal to the user-B speaking, the device 115-b may perform the operations as described below to provide a natural rendering (e.g., playback) of the user-B speaking.

At 315, the device 115-b may determine a set of characteristics of the sound signal based in part on a set of measurements of the sound signal. For example, the device 115-b may measure at least one of an intensity of the sound signal, an angle of arrival of the sound signal, a pitch of the sound signal, a loudness of the sound signal, a distance between the device 115-b and the audio source 205-a of the sound signal in the augmented reality environment, a time of arrival of the sound signal at the device 115-b, or a time of departure of the sound signal from the audio source 205-a of the sound signal in the augmented reality environment, or a combination thereof based in part on receiving the sound signal. Additionally, or alternatively, the device 115-b may translate a representation of the sound signal from a first language into a second language. The representation may, in some cases, be speech in a verbal form or a written form. For example, the device 115-b may convert speech from a verbal form to a written form in a first language (e.g., Chinese), translate the first language to a second language (e.g., Hindi), and convert the written form in the second language to verbal form in the second language. Returning to the above example of the three users, user-B may speak in Chinese, while user-A and/or user-C may speak in Hindi. To facilitate the conversing between the three users, the device 115-b of user-A may translate the speech from user-B to Hindi.

At 320, the device 115-b may apply, to the sound signal, one or more characteristics from the set of characteristics. At 325, the device 115-b may output the representation of the sound signal. For example, device 115-b may output the representation of the sound signal to a listener's ears by controlling one or more characteristics associated with the sound signal, such as an intensity of the sound signal, an angle of arrival of the sound signal, a pitch of the sound signal, a loudness of the sound signal, or the like relative to each input of a pair of Bluetooth earbuds or a Bluetooth headset. Thus, the device 115-b may be capable of outputting a sound signal (e.g., a translated sound signal) and controlling its perception perceived by a listener by using one or more characteristics of the sound signal giving the sound signal a natural rendering in the augmented reality environment.

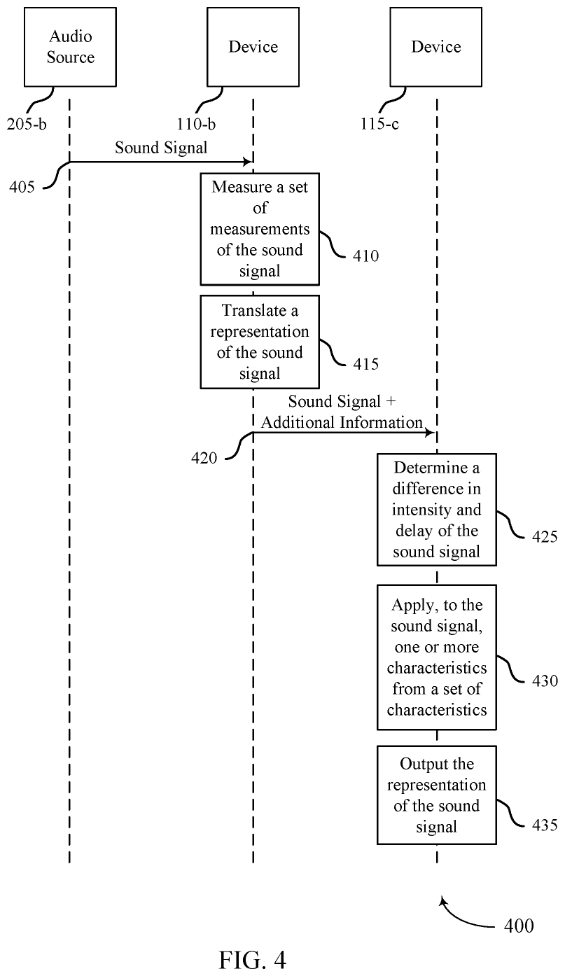

FIG. 4 illustrates an example of a process flow 400 that supports augmented reality language translation in accordance with aspects of the present disclosure. In some examples, the process flow 400 may implement aspects of wireless communications system 100. The process flow 400 may include an audio source 205-b, a device 110-b, and a device 115-c, which may be examples of the corresponding devices described with reference to FIGS. 1 and 2. In the following description of the process flow 400, the operations between the audio source 205-b, the device 110-b, and the device 115-c may be transmitted in a different order than the exemplary order shown, or the operations performed by the audio source 205-b, the device 110-b, and the device 115-c may be performed in different orders or at different times. Certain operations may also be omitted from the process flow 400, and/or other operations may be added to the process flow 400.

At 405, the audio source 205-b may broadcast a sound signal to the device 110-b. In some examples, the device 110-b may be a listening device (e.g., a personal computing device) in communication (e.g., via Bluetooth connection) with the device 115-c, which may be a playback device (e.g., a pair of Bluetooth earbuds, a Bluetooth headset, an HMD). By way of example, in a scene of an augmented reality environment, there may be two users (e.g., user-A, user-B). User-A may be associated with the device 110-b and the device 115-c, while user-B may be another individual participating in the collaborative augmented reality experience. In some examples, user-B may be speaking in the augmented reality environment, for example directly to user-A. As such, the sound signal originating in the augmented reality environment may be related to the user-B speaking. To relate the sound signal to the user-B speaking, the device 110-b may perform the operations as described below to provide a natural rendering (e.g., playback) of the user-B speaking.

At 410, the device 110-b may measure a set of measurements of the sound signal. The device 110-b may support augmented reality speech (e.g., language) translation by measuring one or more characteristics of a sound signal (e.g., an original speech) and using these characteristics during playback of translated speech to enhance augmented reality experience for individuals.

For example, the device 110-b may measure at least one of an intensity of the sound signal, an angle of arrival of the sound signal, a pitch of the sound signal, a loudness of the sound signal, a distance between the device 110-b and the audio source 205-b of the sound signal in the augmented reality environment, or a combination thereof. In some examples, to perform measurements of the sound signal, the device 110-b may be configured with one or more sensors. For example, the device 110-b may be configured with an array of microphones, which the device 110-b may use to perform the example measurements outlined above. By using an array of microphones to, for example, measure at least one of an intensity of the sound signal, an angle of arrival of the sound signal, a pitch of the sound signal, a loudness of the sound signal, a distance between the device 110-b and the audio source 205-b of the sound signal in the augmented reality environment, the device 110-b may determine localization of the audio source 205-b in the augmented reality environment.

At 415, the device 110-b may translate a representation of the sound signal. The representation may be speech in a verbal form or a written form. For example, the device 110-b may convert speech from a verbal form to a written form in a first language (e.g., German, Russian), translate the first language to a second language (e.g., English), and convert the written form in the second language to verbal form in the second language. In some examples, the second language that the device 110-b translates an original language of the sound signal to may be based in part on a default language of an individual associated with the device 110-b and the device 115-c.

For example, an augmented reality application may be installed and executing on the device 110-b to provide an individual associated with the device 110-b an augmented reality experience. In the augmented reality application a setting may be set that may be an indication of a default language of the individual. In the example of process flow 400, the device 110-b may perform the language translation operations to provide benefits and enhancements to the operation of the device 115-c. For example, the device 110-b may have higher processing capabilities compared to the device 115-c, therefore, the operational characteristics, such as power consumption, processor utilization (e.g., DSP, CPU, GPU, processing utilization), and memory usage of the device 115-c may be reduced by allocating (e.g., offloading) the language translation operations to the device 110-b.

At 420, the device 110-b may forward the sound signal along with additional information to the device 115-c. For example, the device 110-b may forward the sound signal along with additional information to the device 115-c via a wired (e.g., Ethernet) or wireless connection (e.g., Bluetooth connection). The sound signal may be a modified version (e.g., translated version) of the original sound signal received from the audio source 205-b (e.g., at 405). For example, the device 110-b may forward a sound signal that includes a translated representation of the sound signal. Additionally, the device 110-b may include an intensity of the sound signal, an angle of arrival of the sound signal, a pitch of the sound signal, a loudness of the sound signal, as part of the additional information. The device 110-b may use the additional information to further enhance playback of the sound signal at the device 110-b.

At 425, the device 115-c may determine a difference in intensity and delay of the sound signal. For example, the device 115-c may determine a difference in intensity associated with the sound signal based in part on the additional information of the sound signal, where the difference in intensity may be a difference between an intensity of the sound signal at a first microphone and an intensity of the sound signal at a second microphone. The device 115-c may additionally, or alternatively, determine a delay including a difference in time of arrival of the sound signal at the first microphone and time of arrival of the sound signal at the second microphone based in part on the additional information of the sound signal.

At 430, the device 115-c may apply, to the sound signal one or more characteristics from a set of characteristics. The one or more characteristics may be, for example, an intensity of the sound signal, an angle of arrival of the sound signal, a pitch of the sound signal, a loudness of the sound signal, or the like. At 435, the device 115-c may output the representation of the sound signal. For example, device 115-c may output the representation of the sound signal to a listener's ears by controlling an intensity of the sound signal, an angle of arrival of the sound signal, a pitch of the sound signal, a loudness of the sound signal, or the like relative to each input of a pair of Bluetooth earbuds or a Bluetooth headset. Thus, the device 115-c may be capable of outputting a sound signal and controlling its perception perceived by a listener by using one or more characteristics of the sound signal giving the sound signal a natural rendering.

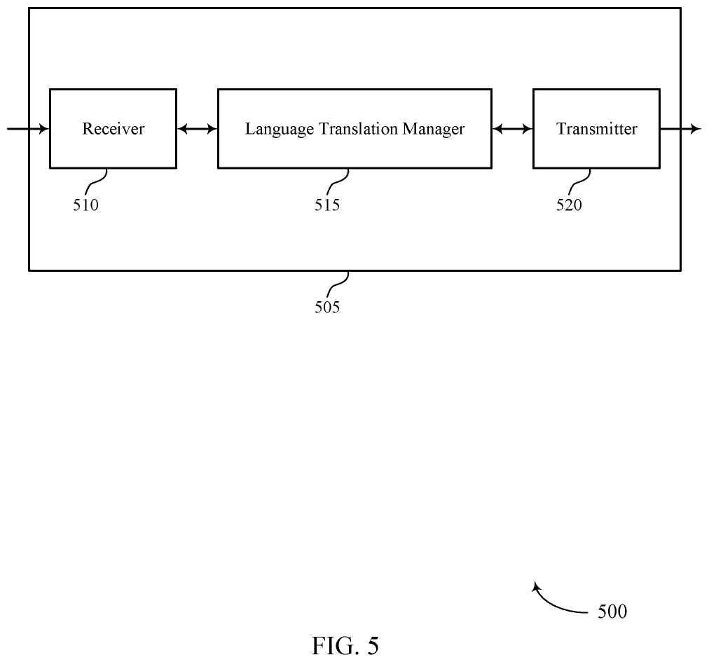

FIG. 5 shows a block diagram 500 of a device 505 that supports augmented reality language translation in accordance with aspects of the present disclosure. The device 505 may be an example of aspects of a device as described herein. The device 505 may include a receiver 510, a language translation manager 515, and a transmitter 520. The device 505 may also include a processor. Each of these components may be in communication with one another (e.g., via one or more buses).

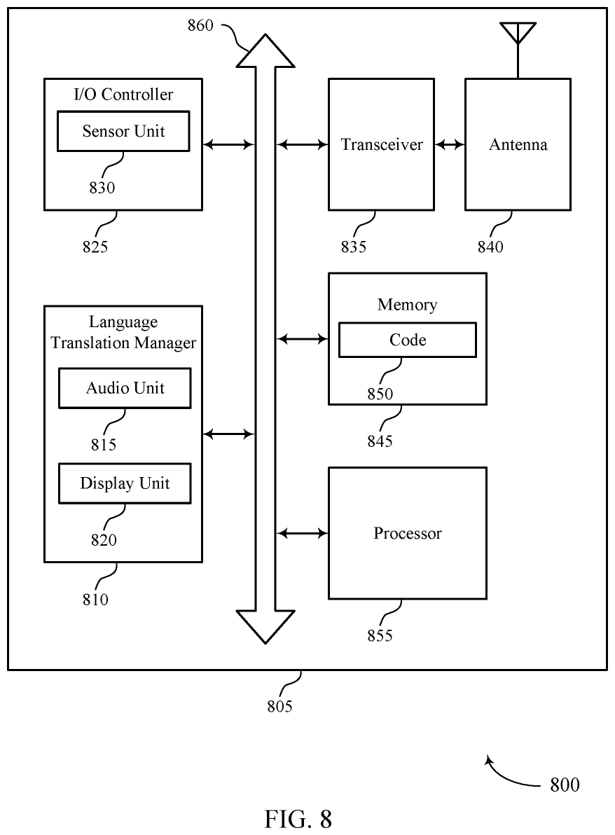

The receiver 510 may receive information such as packets, user data, or control information associated with various information channels (e.g., control channels, data channels, and information related to augmented reality language translation, etc.). Information may be passed on to other components of the device 505. The receiver 510 may be an example of aspects of the transceiver 835 described with reference to FIG. 8. The receiver 510 may utilize a single antenna or a set of antennas.

The language translation manager 515 may identify a sound signal originating in an augmented reality environment, the sound signal including a representation in a language, determine a set of characteristics of the sound signal based on a set of measurements of the sound signal, apply, to the sound signal, one or more characteristics from at least one of the set of characteristics, and output the representation of the sound signal based on applying the one or more characteristics from the at least one of the set of characteristics. The language translation manager 515 may be an example of aspects of the language translation manager 810 described herein.

The language translation manager 515, or its sub-components, may be implemented in hardware, code (e.g., software or firmware) executed by a processor, or any combination thereof. If implemented in code executed by a processor, the functions of the language translation manager 515, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The language translation manager 515, or its sub-components, may be physically located at various positions, including being distributed such that portions of functions are implemented at different physical locations by one or more physical components. In some examples, the language translation manager 515, or its sub-components, may be a separate and distinct component in accordance with various aspects of the present disclosure. In some examples, the language translation manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver module. For example, the transmitter 520 may be an example of aspects of the transceiver 835 described with reference to FIG. 8. The transmitter 520 may utilize a single antenna or a set of antennas.

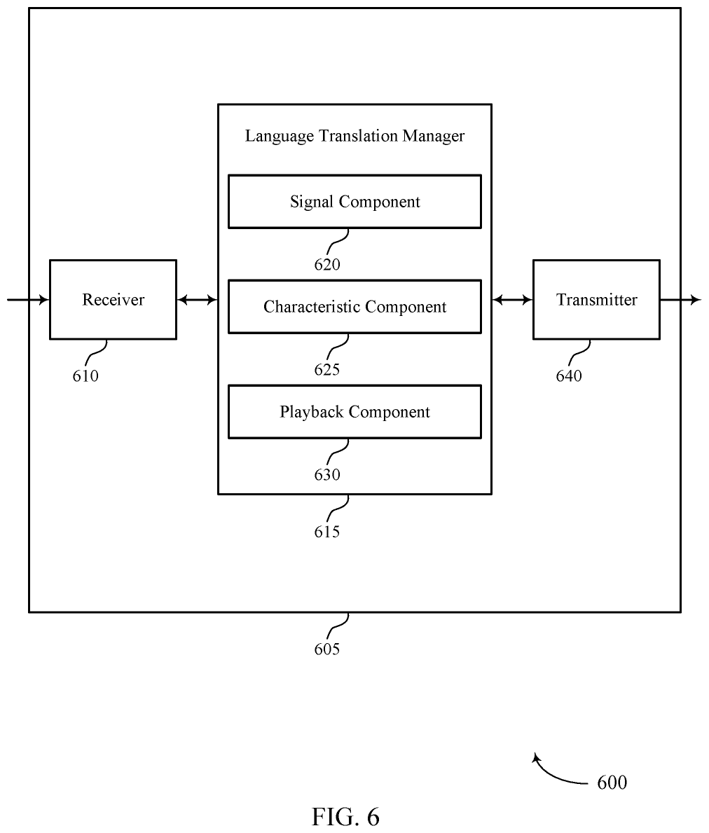

FIG. 6 shows a block diagram 600 of a device 605 that supports augmented reality language translation in accordance with aspects of the present disclosure. The device 605 may be an example of aspects of a device 505 or a device 115 as described herein. The device 605 may include a receiver 610, a language translation manager 615, and a transmitter 640. The device 605 may also include a processor. Each of these components may be in communication with one another (e.g., via one or more buses).

The receiver 610 may receive information such as packets, user data, or control information associated with various information channels (e.g., control channels, data channels, and information related to augmented reality language translation, etc.). Information may be passed on to other components of the device 605. The receiver 610 may be an example of aspects of the transceiver 835 described with reference to FIG. 8. The receiver 610 may utilize a single antenna or a set of antennas.

The language translation manager 615 may be an example of aspects of the language translation manager 515 as described herein. The language translation manager 615 may include a signal component 620, a characteristic component 625, and a playback component 630. The language translation manager 615 may be an example of aspects of the language translation manager 810 described herein.

The signal component 620 may identify a sound signal originating in an augmented reality environment, the sound signal including a representation in a language. The characteristic component 625 may determine a set of characteristics of the sound signal based on a set of measurements of the sound signal. The characteristic component 625 may apply, to the sound signal, one or more characteristics from at least one of the set of characteristics. The playback component 630 may output the representation of the sound signal based on applying the one or more characteristics from the at least one of the set of characteristics.

The transmitter 640 may transmit signals generated by other components of the device 605. In some examples, the transmitter 640 may be collocated with a receiver 610 in a transceiver module. For example, the transmitter 640 may be an example of aspects of the transceiver 835 described with reference to FIG. 8. The transmitter 640 may utilize a single antenna or a set of antennas.

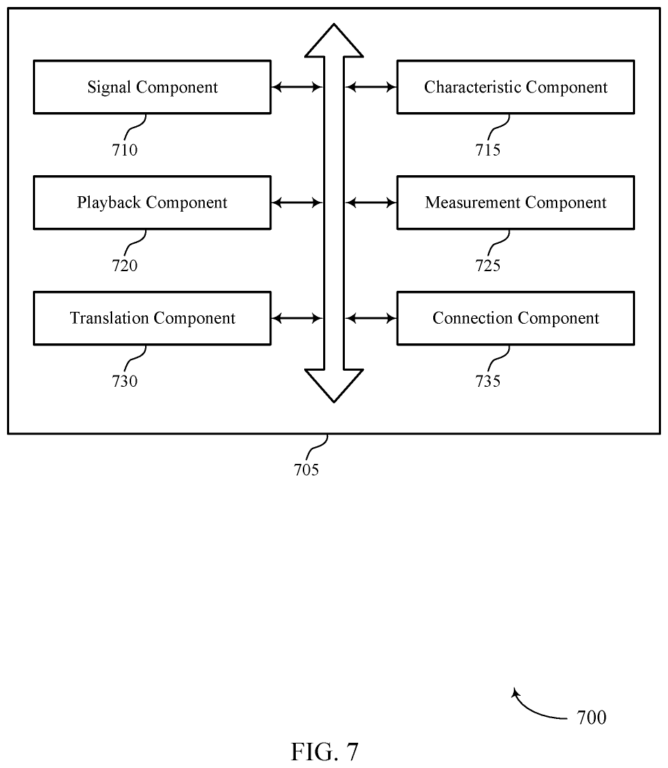

FIG. 7 shows a block diagram 700 of a language translation manager 705 that supports augmented reality language translation in accordance with aspects of the present disclosure. The language translation manager 705 may be an example of aspects of a language translation manager 515, a language translation manager 615, or a language translation manager 810 described herein. The language translation manager 705 may include a signal component 710, a characteristic component 715, a playback component 720, a measurement component 725, a translation component 730, and a connection component 735. Each of these modules may communicate, directly or indirectly, with one another (e.g., via one or more buses).

The signal component 710 may identify a sound signal originating in an augmented reality environment, the sound signal including a representation in a language. The language may include a second language translated from an original language. The representation may include speech in a verbal form or a written form. In some examples, the signal component 710 may receive the sound signal from a source of the sound signal in the augmented reality environment. In some examples, the signal component 710 may receive the sound signal from a second device in communication with the device, where identifying the sound signal is based in part on receiving the sound signal from the second device in communication with the device.

The characteristic component 715 may determine a set of characteristics of the sound signal based on a set of measurements of the sound signal. The characteristic component 715 may apply, to the sound signal, one or more characteristics from at least one of the set of characteristics. In some examples, the characteristic component 715 may apply, to the sound signal, one or more characteristics from at least one of a second set of characteristics that are based on an angular offset.

The playback component 720 may output the representation of the sound signal based on applying the one or more characteristics from the at least one of the set of characteristics. In some examples, outputting the representation of the sound signal may be based in part on applying the one or more characteristics from at least one of the second set of characteristics. The playback component 720 may output the translated representation of the sound signal in the second language based on applying the one or more characteristics from the at least one of the set of characteristics.

The measurement component 725 may measure at least one of an intensity of the sound signal, an angle of arrival of the sound signal, a pitch of the sound signal, a loudness of the sound signal, a distance between the device and the source of the sound signal in the augmented reality environment, a time of arrival of the sound signal at the device, or a time of departure of the sound signal from the source of the sound signal in the augmented reality environment, or a combination thereof based on receiving the sound signal. In some examples, the set of measurements of the sound signal includes the intensity of the sound signal, the angle of arrival of the sound signal, the pitch of the sound signal, the loudness of the sound signal, the distance between the device and the source of the sound signal in the augmented reality environment, the time of arrival of the sound signal at the device, or the time of departure of the sound signal from the source of the sound signal in the augmented reality environment, or a combination thereof. In some examples, the measurement component 725 may receive the set of measurements of the sound signal from the second device in communication with the device based on the connection, where determining the set of characteristics of the sound signal is based on receiving the set of measurements of the sound signal.

In some examples, the measurement component 725 may identify a time of departure of the sound signal from a source of the sound signal in the augmented reality environment based on the set of measurements of the sound signal. In some examples, the measurement component 725 may determine a delay including a difference in time of arrival of the sound signal at a first microphone of the device and time of arrival of the sound signal at a second microphone of the device based on the set of measurements of the sound signal. In some examples, the set of characteristics includes the time of departure of the sound signal and the delay associated with the difference in the times of the arrivals. In some examples, the measurement component 725 may determine a difference in intensity associated with the sound signal based on the set of measurements of the sound signal, where the difference in intensity includes a difference between an intensity of the sound signal at a first microphone of the device and an intensity of the sound signal at a second microphone of the device. In some examples, the set of characteristics includes the difference in intensity.

In some examples, the measurement component 725 may determine an angular offset between the device and a source of the sound signal in the augmented reality environment using a sensor of the device. In some examples, the measurement component 725 may determine the second set of characteristics that are based on the angular offset, where the second set of characteristics includes at least one of an intensity of the sound signal, a pitch of the sound signal, a loudness of the sound signal, or a combination thereof. The translation component 730 may translate the representation of the sound signal from the language into the second language. The connection component 735 may establish a connection with the second device based on a connection procedure.

FIG. 8 shows a diagram of a system 800 including a device 805 that supports augmented reality language translation in accordance with aspects of the present disclosure. The device 805 may be an example of or include the components of device 505, device 605, or a device as described herein. The device 805 may include components for bi-directional voice and data communications including components for transmitting and receiving communications, including a language translation manager 810, an I/O controller 825, a transceiver 835, an antenna 8340, memory 845, and a processor 855. These components may be in electronic communication via one or more buses (e.g., bus 860).

The language translation manager 810 may identify a sound signal originating in an augmented reality environment, the sound signal including a representation in a language, determine a set of characteristics of the sound signal based on a set of measurements of the sound signal, apply, to the sound signal, one or more characteristics from at least one of the set of characteristics, and output the representation of the sound signal based on applying the one or more characteristics from the at least one of the set of characteristics.

In some examples, the language translation manager 810 may include an audio unit 815 and a display unit 820. The audio unit 815 may be a headset, a pair of Bluetooth earbuds or a Bluetooth headset, or the like capable of broadcasting (e.g., playback of) audio signals originating in an augmented reality environment. In some examples, the audio unit 815 may receive rendered audio signals from a rendering device (e.g., a personal computing device). The display unit 820 may be a partially transmissive display device. The display unit 820 may be configured to be in front of an individual's eyes, and thus the individual can be immersed into an augmented reality environment. The display unit 820 may be configured to determine, track and adjust a direction of the individual's head for changing a display image projected via the display unit 820, so as to follow the movement of individual's head. Because the device 805 and a rendering device (e.g., a personal computing device or the device 805 may operate as the rendering device) may be configured to support a virtual rendering (e.g., natural translated speech playback), the individual can experience a further enhanced sense of immersion into the augmented reality environment. In some examples, the display unit 820 may be a liquid crystal display (LCD), a cathode ray tube (CRT) display, and the like.

The I/O controller 825 may manage input and output signals for the device 805. The I/O controller 825 may also manage peripherals not integrated into the device 805. In some cases, the I/O controller 825 may represent a physical connection or port to an external peripheral. In some cases, the I/O controller 825 may utilize an operating system such as iOS, ANDROID, MS-DOS, MS-WINDOWS, OS/2, UNIX, LINUX, or another known operating system. In other cases, the I/O controller 825 may represent or interact with a modem, a keyboard, a mouse, a touchscreen, or a similar device. In some cases, the I/O controller 825 may be implemented as part of the processor 855. In some cases, an individual may interact with the device 805 via the I/O controller 825 or via hardware components controlled by the I/O controller 825.

In some examples, the I/O controller 825 may include a sensor unit 830. The sensor unit 830 may include one or more sensors that support augmented reality language translation. The sensor unit 830 may also be configured with multiple functionalities. For example, a single sensor unit 830 may be capable of performing operations related to sound listening, sound broadcasting (e.g., playback), sound measurements, and the like. By way of example, a sensor unit 830 may include a single microphone or an array of microphones capable of measuring at least one of an intensity of a sound signal, an angle of arrival of the sound signal, a pitch of the sound signal, a loudness of the sound signal, a distance between the device 805 and a source of the sound signal in an augmented reality environment, a time of arrival of the sound signal at the device 805, or a time of departure of the sound signal from the source of the sound signal in the augmented reality environment, or a combination.

The transceiver 835 may communicate bi-directionally, via one or more antennas, wired, or wireless links as described above. For example, the transceiver 835 may represent a wireless transceiver and may communicate bi-directionally with another wireless transceiver. The transceiver 835 may also include a modem to modulate the packets and provide the modulated packets to the antennas for transmission, and to demodulate packets received from the antennas. In some examples, the device 805 may include a single antenna 840. However, in some cases the device 805 may have more than one antenna 840, which may be capable of concurrently transmitting or receiving multiple wireless transmissions.

The memory 845 may include RAM and ROM. The memory 845 may store computer-readable, computer-executable code 850 including instructions that, when executed, cause the processor 855 to perform various functions described herein. In some cases, the memory 845 may contain, among other things, a BIOS which may control basic hardware or software operation such as the interaction with peripheral components or devices.

The code 850 may include instructions to implement aspects of the present disclosure, including instructions to support language translation. The code 850 may be stored in a non-transitory computer-readable medium such as system memory or other type of memory. In some cases, the code 850 may not be directly executable by the processor 855 but may cause a computer (e.g., when compiled and executed) to perform functions described herein.

The processor 855 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some examples, the processor 855 may be configured to operate a memory array using a memory controller. In other cases, a memory controller may be integrated into the processor 855. The processor 855 may be configured to execute computer-readable instructions stored in a memory (e.g., the memory 845) to cause the device 805 to perform various functions (e.g., functions or tasks supporting augmented reality language translation).

As detailed above, the language translation manager 810 and/or one or more components of the language translation manager 810 may perform and/or be a means for performing, either alone or in combination with other elements, one or more operations for supporting augmented reality language translation.

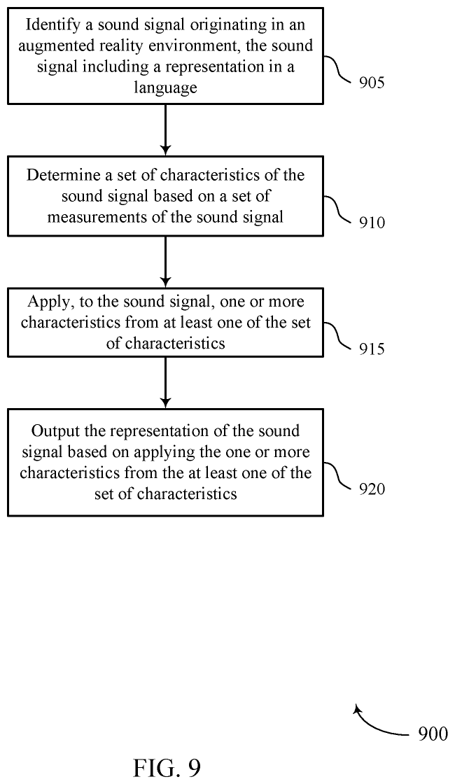

FIG. 9 shows a flowchart illustrating a method 900 that supports augmented reality language translation in accordance with aspects of the present disclosure. The operations of method 900 may be implemented by a device or its components as described herein. For example, the operations of method 900 may be performed by a language translation manager as described with reference to FIGS. 5 through 8. In some examples, a device may execute a set of instructions to control the functional elements of the device to perform the functions described below. Additionally or alternatively, a device may perform aspects of the functions described below using special-purpose hardware.

At 905, the device may identify a sound signal originating in an augmented reality environment, the sound signal including a representation in a language. The operations of 905 may be performed according to the methods described herein. In some examples, aspects of the operations of 905 may be performed by a signal component as described with reference to FIGS. 5 through 8.

At 910, the device may determine a set of characteristics of the sound signal based on a set of measurements of the sound signal. The operations of 910 may be performed according to the methods described herein. In some examples, aspects of the operations of 910 may be performed by a characteristic component as described with reference to FIGS. 5 through 8.

At 915, the device may apply, to the sound signal, one or more characteristics from at least one of the set of characteristics. The operations of 915 may be performed according to the methods described herein. In some examples, aspects of the operations of 915 may be performed by a characteristics component as described with reference to FIGS. 5 through 8.

At 920, the device may output the representation of the sound signal based on applying the one or more characteristics from the at least one of the set of characteristics. The operations of 920 may be performed according to the methods described herein. In some examples, aspects of the operations of 920 may be performed by a playback component as described with reference to FIGS. 5 through 8.

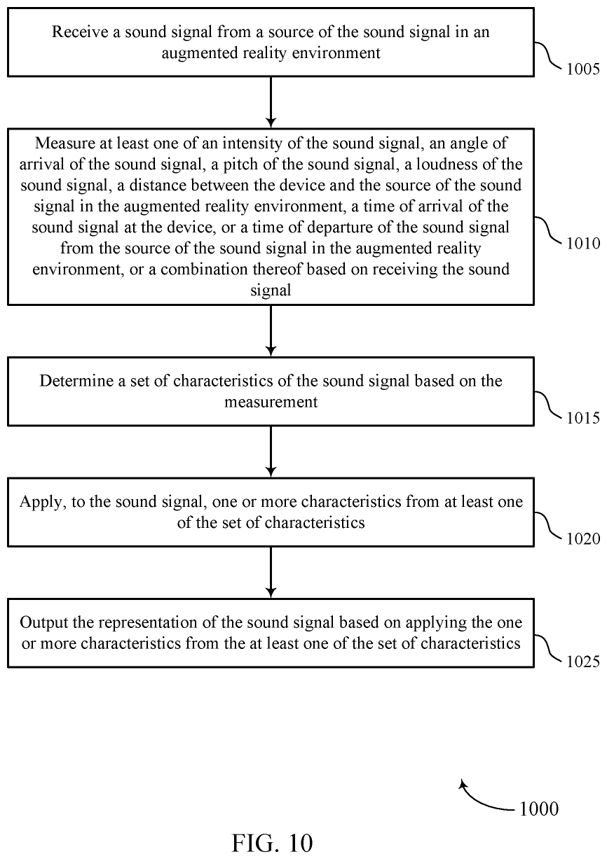

FIG. 10 shows a flowchart illustrating a method 1000 that supports augmented reality language translation in accordance with aspects of the present disclosure. The operations of method 1000 may be implemented by a device or its components as described herein. For example, the operations of method 1000 may be performed by a language translation manager as described with reference to FIGS. 5 through 8. In some examples, a device may execute a set of instructions to control the functional elements of the device to perform the functions described below. Additionally or alternatively, a device may perform aspects of the functions described below using special-purpose hardware.

At 1005, the device may receive a sound signal from a source of the sound signal in the augmented reality environment. The operations of 1005 may be performed according to the methods described herein. In some examples, aspects of the operations of 1005 may be performed by a signal component as described with reference to FIGS. 5 through 8.

At 1010, the device may measure at least one of an intensity of the sound signal, an angle of arrival of the sound signal, a pitch of the sound signal, a loudness of the sound signal, a distance between the device and the source of the sound signal in the augmented reality environment, a time of arrival of the sound signal at the device, or a time of departure of the sound signal from the source of the sound signal in the augmented reality environment, or a combination thereof based on receiving the sound signal. In some examples, a set of measurements of the sound signal includes the intensity of the sound signal, the angle of arrival of the sound signal, the pitch of the sound signal, the loudness of the sound signal, the distance between the device and the source of the sound signal in the augmented reality environment, the time of arrival of the sound signal at the device, or the time of departure of the sound signal from the source of the sound signal in the augmented reality environment, or a combination thereof. The operations of 1010 may be performed according to the methods described herein. In some examples, aspects of the operations of 1010 may be performed by a measurement component as described with reference to FIGS. 5 through 8.

At 1015, the device may determine a set of characteristics of the sound signal based on the measurement. The operations of 1015 may be performed according to the methods described herein. In some examples, aspects of the operations of 1015 may be performed by a characteristic component as described with reference to FIGS. 5 through 8.

At 1020, the device may apply, to the sound signal, one or more characteristics from at least one of the set of characteristics. The operations of 1020 may be performed according to the methods described herein. In some examples, aspects of the operations of 1020 may be performed by a characteristics component as described with reference to FIGS. 5 through 8.

At 1025, the device may output the representation of the sound signal based on applying the one or more characteristics from the at least one of the set of characteristics. The operations of 1025 may be performed according to the methods described herein. In some examples, aspects of the operations of 1025 may be performed by a playback component as described with reference to FIGS. 5 through 8.

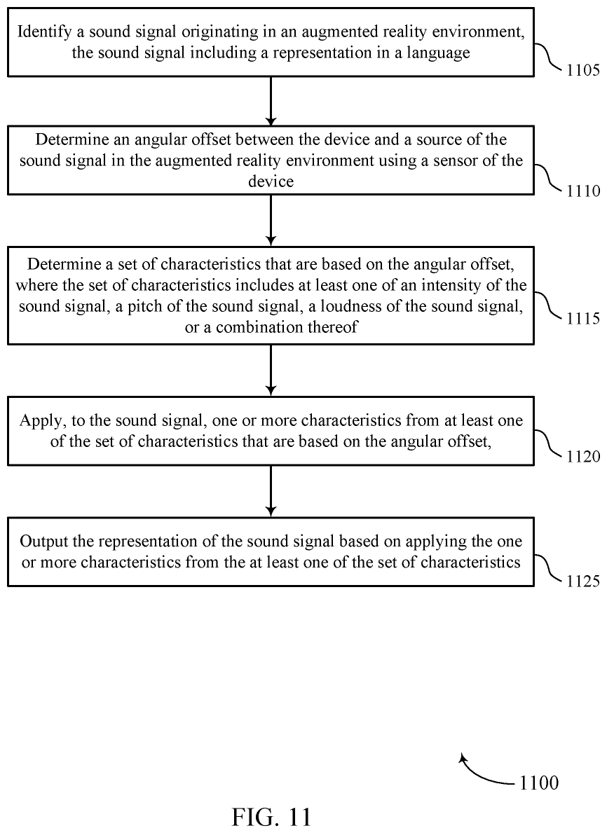

FIG. 11 shows a flowchart illustrating a method 1100 that supports augmented reality language translation in accordance with aspects of the present disclosure. The operations of method 1100 may be implemented by a device or its components as described herein. For example, the operations of method 1100 may be performed by a language translation manager as described with reference to FIGS. 5 through 8. In some examples, a device may execute a set of instructions to control the functional elements of the device to perform the functions described below. Additionally or alternatively, a device may perform aspects of the functions described below using special-purpose hardware.

At 1105, the device may identify a sound signal originating in an augmented reality environment, the sound signal including a representation in a language. The operations of 1105 may be performed according to the methods described herein. In some examples, aspects of the operations of 1105 may be performed by a signal component as described with reference to FIGS. 5 through 8.

At 1110, the device may determine an angular offset between the device and a source of the sound signal in the augmented reality environment using a sensor of the device. The operations of 1110 may be performed according to the methods described herein. In some examples, aspects of the operations of 1110 may be performed by a measurement component as described with reference to FIGS. 5 through 8.

At 1115, the device may determine a set of characteristics that are based on the angular offset, where the set of characteristics includes at least one of an intensity of the sound signal, a pitch of the sound signal, a loudness of the sound signal, or a combination thereof. The operations of 1115 may be performed according to the methods described herein. In some examples, aspects of the operations of 1115 may be performed by a measurement component as described with reference to FIGS. 5 through 8.

At 1120, the device may apply, to the sound signal, one or more characteristics from at least one of the set of characteristics that are based on the angular offset. The operations of 1120 may be performed according to the methods described herein. In some examples, aspects of the operations of 1120 may be performed by a characteristic component as described with reference to FIGS. 5 through 8.

At 1125, the device may output the representation of the sound signal based on applying the one or more characteristics from the at least one of the set of characteristics. The operations of 1125 may be performed according to the methods described herein. In some examples, aspects of the operations of 1125 may be performed by a playback component as described with reference to FIGS. 5 through 8.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned herein as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for language translation at a device, comprising:
identifying a sound signal originating in an augmented reality environment, the sound signal comprising a representation in a language;
determining a set of characteristics of the sound signal based at least in part on a set of measurements of the sound signal;
applying, to the sound signal, one or more characteristics from at least one of the set of characteristics; and
outputting the representation of the sound signal based at least in part on applying the one or more characteristics from the at least one of the set of characteristics.

2. The method of claim 1, wherein the language comprises a second language translated from an original language.

3. The method of claim 1, further comprising:
receiving the sound signal from a source of the sound signal in the augmented reality environment; and
measuring at least one of an intensity of the sound signal, an angle of arrival of the sound signal, a pitch of the sound signal, a loudness of the sound signal, a distance between the device and the source of the sound signal in the augmented reality environment, a time of arrival of the sound signal at the device, or a time of departure of the sound signal from the source of the sound signal in the augmented reality environment, or a combination thereof based at least in part on receiving the sound signal,
wherein the set of measurements of the sound signal comprises the intensity of the sound signal, the angle of arrival of the sound signal, the pitch of the sound signal, the loudness of the sound signal, the distance between the device and the source of the sound signal in the augmented reality environment, the time of arrival of the sound signal at the device, or the time of departure of the sound signal from the source of the sound signal in the augmented reality environment, or a combination thereof.

4. The method of claim 1, further comprising:
identifying a time of departure of the sound signal from a source of the sound signal in the augmented reality environment based at least in part on the set of measurements of the sound signal; and
determining a delay comprising a difference in time of arrival of the sound signal at a first microphone of the device and time of arrival of the sound signal at a second microphone of the device based at least in part on the set of measurements of the sound signal,
wherein the set of characteristics comprises the time of departure of the sound signal and the delay associated with the difference in the times of the arrivals.

5. The method of claim 1, further comprising:
determining a difference in intensity associated with the sound signal based at least in part on the set of measurements of the sound signal, wherein the difference in intensity comprises a difference between an intensity of the sound signal at a first microphone of the device and an intensity of the sound signal at a second microphone of the device,
wherein the set of characteristics comprises the difference in intensity.

6. The method of claim 1, further comprising:
determining an angular offset between the device and a source of the sound signal in the augmented reality environment using a sensor of the device;
determining a second set of characteristics that are based at least in part on the angular offset, wherein the second set of characteristics comprises at least one of an intensity of the sound signal, a pitch of the sound signal, a loudness of the sound signal, or a combination thereof; and
applying, to the sound signal, one or more characteristics from at least one of the second set of characteristics that are based at least in part on the angular offset,
wherein outputting the representation of the sound signal is based at least in part on applying the one or more characteristics from at least one of the second set of characteristics.

7. The method of claim 1, further comprising:
translating a representation of the sound signal from the language into a second language, wherein outputting the representation of the sound signal comprises; and
outputting the translated representation of the sound signal in the second language based at least in part on applying the one or more characteristics from the at least one of the set of characteristics.

8. The method of claim 1, further comprising:
establishing a connection with a second device based at least in part on a connection procedure; and
receiving the sound signal from the second device in communication with the device, wherein identifying the sound signal is based at least in part on receiving the sound signal from the second device in communication with the device.

9. The method of claim 8, further comprising:
receiving the set of measurements of the sound signal from the second device in communication with the device based at least in part on the connection, wherein determining the set of characteristics of the sound signal is based at least in part on receiving the set of measurements of the sound signal.

10. The method of claim 1, wherein the device comprises a pair of Bluetooth earbuds or a Bluetooth headset.

11. The method of claim 1, wherein the device comprises a user equipment (UE).

12. The method of claim 1, wherein the representation comprises speech in a verbal form or a written form.

13. An apparatus for language translation, comprising:
a processor,
memory in electronic communication with the processor; and
instructions stored in the memory and executable by the processor to cause the apparatus to:
identify a sound signal originating in an augmented reality environment, the sound signal comprising a representation in a language;
determine a set of characteristics of the sound signal based at least in part on a set of measurements of the sound signal;
apply, to the sound signal, one or more characteristics from at least one of the set of characteristics; and
output the representation of the sound signal based at least in part on applying the one or more characteristics from the at least one of the set of characteristics.

14. The apparatus of claim 13, wherein the language comprises a second language translated from an original language.

15. The apparatus of claim 13, wherein the instructions are further executable by the processor to cause the apparatus to:
receive the sound signal from a source of the sound signal in the augmented reality environment; and
measure at least one of an intensity of the sound signal, an angle of arrival of the sound signal, a pitch of the sound signal, a loudness of the sound signal, a distance between the apparatus and the source of the sound signal in the augmented reality environment, a time of arrival of the sound signal at the apparatus, or a time of departure of the sound signal from the source of the sound signal in the augmented reality environment, or a combination thereof based at least in part on receiving the sound signal,
wherein the set of measurements of the sound signal comprises the intensity of the sound signal, the angle of arrival of the sound signal, the pitch of the sound signal, the loudness of the sound signal, the distance between the apparatus and the source of the sound signal in the augmented reality environment, the time of arrival of the sound signal at the apparatus, or the time of departure of the sound signal from the source of the sound signal in the augmented reality environment, or a combination thereof.

16. The apparatus of claim 13, wherein the instructions are further executable by the processor to cause the apparatus to:
identify a time of departure of the sound signal from a source of the sound signal in the augmented reality environment based at least in part on the set of measurements of the sound signal; and
determine a delay comprising a difference in time of arrival of the sound signal at a first microphone of the apparatus and time of arrival of the sound signal at a second microphone of the apparatus based at least in part on the set of measurements of the sound signal,
wherein the set of characteristics comprises the time of departure of the sound signal and the delay associated with the difference in the times of the arrivals.

17. The apparatus of claim 13, wherein the instructions are further executable by the processor to cause the apparatus to:
determine a difference in intensity associated with the sound signal based at least in part on the set of measurements of the sound signal, wherein the difference in intensity comprises a difference between an intensity of the sound signal at a first microphone of the apparatus and an intensity of the sound signal at a second microphone of the apparatus,
wherein the set of characteristics comprises the difference in intensity.

18. The apparatus of claim 13, wherein the instructions are further executable by the processor to cause the apparatus to:
determine an angular offset between the apparatus and a source of the sound signal in the augmented reality environment using a sensor of the apparatus;
determine a second set of characteristics that are based at least in part on the angular offset, wherein the second set of characteristics comprises at least one of an intensity of the sound signal, a pitch of the sound signal, a loudness of the sound signal, or a combination thereof; and
apply, to the sound signal, one or more characteristics from at least one of the second set of characteristics that are based at least in part on the angular offset,
wherein outputting the representation of the sound signal is based at least in part on applying the one or more characteristics from at least one of the second set of characteristics.

19. The apparatus of claim 13, wherein the instructions are further executable by the processor to cause the apparatus to:
translate a representation of the sound signal from the language into a second language, wherein outputting the representation of the sound signal comprises; and
output the translated representation of the sound signal in the second language based at least in part on applying the one or more characteristics from the at least one of the set of characteristics.

20. An apparatus for language translation, comprising:
means for identifying a sound signal originating in an augmented reality environment, the sound signal comprising a representation in a language;
means for determining a set of characteristics of the sound signal based at least in part on a set of measurements of the sound signal;
means for applying, to the sound signal, one or more characteristics from at least one of the set of characteristics; and
means for outputting the representation of the sound signal based at least in part on applying the one or more characteristics from the at least one of the set of characteristics.
